(19) United States
(12) Patent Application Publication
(10) Pub. No.: US 2024/0287844 A1
(43) Pub. Date: Aug. 29, 2024

(54) OPERATION ASSISTANCE SYSTEM AND CONTROL DEVICE

(71) Applicant: AISIN CORPORATION, Kariya (JP)

(72) Inventors: Ryu MIYASHIRO, Kariya-shi (JP); Maiko ITO, Kariya-shi (JP)

(73) Assignee: AISIN CORPORATION, Kariya (JP)

(21) Appl. No.: 18/420,984

(22) Filed: Jan. 24, 2024

(30) Foreign Application Priority Data
Feb. 24, 2023 (JP) 2023-027528

(51) Int. Cl. E05F 15/73; E05F 15/40; E05F 15/60

(52) U.S. Cl. CPC E05F 15/73; E05F 15/40; E05F 15/60; E05Y 2201/408; E05Y 2400/44; E05Y 2900/531

(57) ABSTRACT

An operation assistance system for assisting a user in operating an opening and closing portion includes: a sensor configured to detect an acceleration applied to the opening and closing portion; a drive unit configured to generate a driving force for displacing the opening and closing portion; a manual operation detection unit configured to detect, based on the acceleration detected by the sensor, a manual operation of displacing the opening and closing portion when the user applies a force to the opening and closing portion; a state detection unit configured to detect, based on an opening degree of the opening and closing portion, whether the opening and closing portion is in a small opening degree state in which the opening and closing portion has a first opening degree or less, or in an intermediate holding state in which the opening and closing portion is held at a second opening degree larger than the first opening degree; an obstacle detection unit configured to detect a distance from the opening and closing portion to an obstacle present in an area in an opening direction of the opening and closing portion; and a drive control unit configured to control the drive unit to reduce or increase an operation force of the user required for the manual operation based on a detection result of the manual operation detection unit, a detection result of the state detection unit, and a detection result of the obstacle detection unit. When the user performs an opening operation of opening the opening and closing portion in the small opening degree state and the obstacle is present within a predetermined distance from the opening and closing portion, the drive control unit controls the drive unit to generate a first braking force for increasing the operation force required for the opening operation, and when the user performs a first additional opening operation of further opening the opening and closing portion in the intermediate holding state, the drive control unit controls the drive unit to generate a second braking force that is a force for increasing the operation force required for the first additional opening operation and is smaller than the first braking force.

### CROSS REFERENCE TO RELATED APPLICATIONS

This application is based on and claims priority under 35 U.S.C. § 119 to Japanese Patent Application 2023-027528, filed on Feb. 24, 2023, the entire content of which is incorporated herein by reference.

### TECHNICAL FIELD

This disclosure relates to an operation assistance system and a control device.

### BACKGROUND DISCUSSION

In a moving body such as a vehicle, a system is used in which, when a user operates an opening and closing portion such as a door, the opening and closing portion is driven to assist the operation of the user.

Examples of the related art include JP 2020-29765A (Reference 1).

In the above system, when the user manually performs an opening operation of opening the opening and closing portion, if an obstacle is detected in the vicinity of the opening and closing portion, control of restricting the opening operation, that is, control of generating a braking force so as to increase an operation force of the user required for the opening operation may be performed. When performing such control, according to the related art, the opening operation is excessively restricted, making it difficult for the user to open the opening and closing portion to a desired opening degree, which may impair convenience.

A need thus exists for an operation assistance system and a control device which are not susceptible to the drawback mentioned above.

### SUMMARY

An aspect of this disclosure relates to an operation assistance system for assisting a user in operating an opening and closing portion, and the operation assistance system includes: a sensor configured to detect an acceleration applied to the opening and closing portion; a drive unit configured to generate a driving force for displacing the opening and closing portion; a manual operation detection unit configured to detect, based on the acceleration detected by the sensor, a manual operation of displacing the opening and closing portion when the user applies a force to the opening and closing portion; a state detection unit configured to detect, based on an opening degree of the opening and closing portion, whether the opening and closing portion is in a small opening degree state in which the opening and closing portion has a first opening degree or less, or in an intermediate holding state in which the opening and closing portion is held at a second opening degree larger than the first opening degree; an obstacle detection unit configured to detect a distance from the opening and closing portion to an obstacle present in an area in an opening direction of the opening and closing portion; and a drive control unit configured to control the drive unit to reduce or increase an operation force of the user required for the manual operation based on a detection result of the manual operation detection unit, a detection result of the state detection unit, and a detection result of the obstacle detection unit. When the user performs an opening operation of opening the opening and closing portion in the small opening degree state and the obstacle is present within a predetermined distance from the opening and closing portion, the drive control unit controls the drive unit to generate a first braking force for increasing the operation force required for the opening operation, and when the user performs a first additional opening operation of further opening the opening and closing portion in the intermediate holding state, the drive control unit controls the drive unit to generate a second braking force that is a force for increasing the operation force required for the first additional opening operation and is smaller than the first braking force.

Another aspect of this disclosure relates to a control device that executes processing of controlling a drive unit that generates a driving force for displacing an opening and closing portion, and the control device includes: a manual operation detection unit configured to detect, based on an acceleration applied to the opening and closing portion, a manual operation of displacing the opening and closing portion when a user applies a force to the opening and closing portion; a state detection unit configured to detect, based on an opening degree of the opening and closing portion, whether the opening and closing portion is in a small opening degree state in which the opening and closing portion has a first opening degree or less, or in an intermediate holding state in which the opening and closing portion is held at a second opening degree larger than the first opening degree; an obstacle detection unit configured to detect a distance from the opening and closing portion to an obstacle present in an area in an opening direction of the opening and closing portion; and a drive control unit configured to control the drive unit to reduce or increase an operation force of the user required for the manual operation based on a detection result of the manual operation detection unit, a detection result of the state detection unit, and a detection result of the obstacle detection unit. When the user performs an opening operation of opening the opening and closing portion in the small opening degree state and the obstacle is present within a predetermined distance from the opening and closing portion, the drive control unit controls the drive unit to generate a first braking force for increasing the operation force required for the opening operation, and when the user performs a first additional opening operation of further opening the opening and closing portion in the intermediate holding state, the drive control unit controls the drive unit to generate a second braking force that is a force for increasing the operation force required for the first additional opening operation and is smaller than the first braking force.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram showing an example of a system configuration of an operation assistance system according to an embodiment;

FIG. 2 is a view showing an example of a configuration of doors according to the embodiment;

FIG. 3 is a diagram showing an example of a functional configuration of an ECU according to the embodiment;

FIG. 4 is a diagram showing an example of a relationship between an opening degree and a state of the door according to the embodiment;

FIG. 5 is a diagram showing an example of a relationship among a state of the door, a manual operation, presence or absence of an obstacle, driving force control, and an operation force according to the embodiment; and

FIG. 6 is a flowchart showing an example of processing executed by the ECU according to the embodiment.

### DETAILED DESCRIPTION

Hereinafter, exemplary embodiments disclosed here will be disclosed. Configurations of embodiments to be described below, and operations, results, and effects of the configurations are examples. Embodiments disclosed here can be implemented by configurations other than the configurations disclosed in the embodiments to be described below, and at least one of various effects based on a basic configuration and a derivative effect can be obtained.

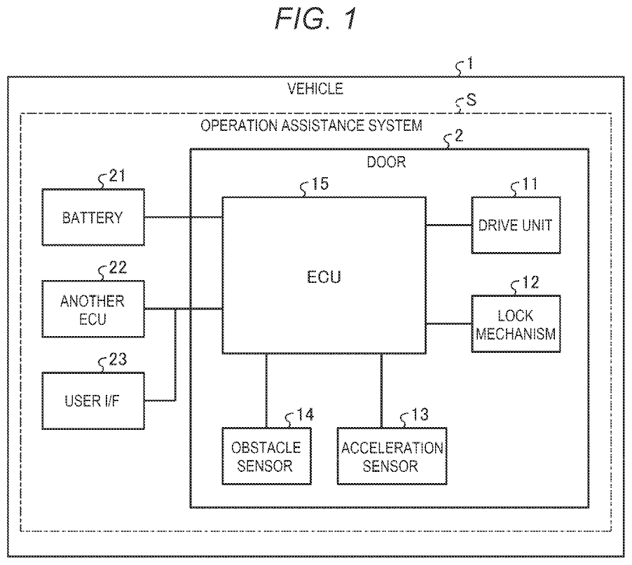

FIG. 1 is a diagram showing an example of a system configuration of an operation assistance system S according to an embodiment. The operation assistance system S according to the embodiment is a system that assists a user (such as an occupant) in operating a door 2 (an example of an opening and closing portion) mounted on a vehicle 1 such as a four-wheel automobile.

The operation assistance system S includes a drive unit 11 (an example of a drive unit), a lock mechanism 12, an acceleration sensor 13 (an example of a sensor), an obstacle sensor 14, and an electronic control unit (ECU) 15 (an example of a control device).

The drive unit 11 is a unit that generates a driving force for displacing the door 2, and may be implemented by using an actuator including an electric motor, a link mechanism, or the like. The drive unit 11 is installed on, for example, a hinge portion of the door 2, and generates the driving force for displacing the door 2 in an opening direction or a closing direction according to a control signal from the ECU 15 to be described later.

The lock mechanism 12 is a mechanism that switches the door 2 between a locked state and a released state. The lock mechanism 12 according to the embodiment includes an actuator that is electrically operated according to a control signal from the ECU 15, and switches between the locked state and the released state according to the control signal.

The acceleration sensor 13 is a sensor that detects an acceleration applied to the door 2. The acceleration sensor 13 may be, for example, a three-axis acceleration sensor capable of detecting an acceleration in each of an X direction, a Y direction, and a Z direction orthogonal to one another. The X direction, the Y direction, and the Z direction may be, for example, a width (left-right) direction, a front-rear direction, and an upper-lower direction of the vehicle 1, respectively. The acceleration sensor 13 is installed, for example, inside each door 2. The acceleration sensor 13 may be integrated with the ECU 15.

The obstacle sensor 14 is a sensor that detects an obstacle present around the vehicle 1. The obstacle sensor 14 is, for example, a distance sensor capable of measuring a distance from a vehicle body (such as the door 2) to the obstacle, and may be, for example, an ultrasonic sensor, a millimeter wave sensor, or a light detection and ranging (LiDAR) sensor.

The ECU 15 is an information processing device that controls the drive unit 11 and the lock mechanism 12. The ECU 15 may be implemented by using a central processing unit (CPU), a memory, a field programmable gate array (FPGA), an application specific integrated circuit (ASIC), an input interface (I/F), an output I/F, or the like. The ECU 15 is connected to a battery 21 mounted on the vehicle 1 via a predetermined power transmission path. The ECU 15 is connected to another ECU 22, a user I/F 23, and the like mounted on the vehicle 1 via a communication network such as a controller area network (CAN). Another ECU 22 may be, for example, an ECU that executes processing for controlling traveling of the vehicle 1. The user I/F 23 may be, for example, an operation unit that is mounted in the vehicle and allows the user (occupant) to perform a setting operation or the like.

The ECU 15 according to the embodiment executes processing for controlling the drive unit 11 and the like so as to assist the user in operating the door 2 based on information acquired from the acceleration sensor 13 and the like.

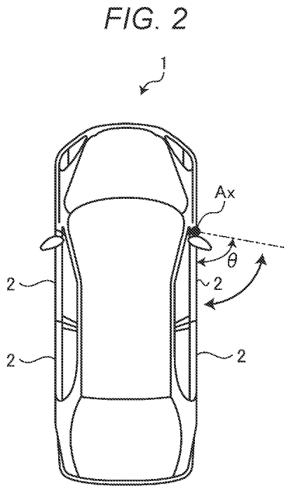

FIG. 2 is a diagram showing an example of a configuration of the doors 2 according to the embodiment. FIG. 2 shows a top view of the vehicle 1 on which the operation assistance system S according to the embodiment is mounted. As shown in FIG. 2, the door 2 according to the embodiment is a hinge door that rotates about a rotation axis Ax. In FIG. 2, θ indicates an opening degree of the door 2. The opening degree θ according to the embodiment is an angle formed between a side surface of the door 2 in a closed state and a side surface of the door 2 displaced from the closed state. When the user performs a manual operation of opening or closing the door 2 by applying a force to the door 2, the operation assistance system S according to the embodiment executes processing for assisting the manual operation.

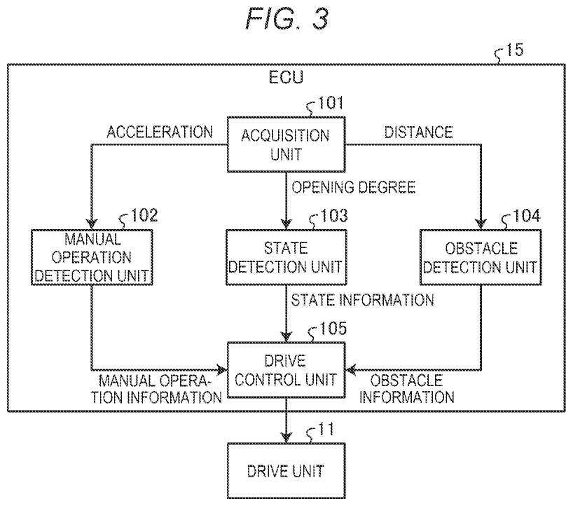

FIG. 3 is a diagram showing an example of a functional configuration of the ECU 15 according to the embodiment. The ECU 15 includes an acquisition unit 101, a manual operation detection unit 102, a state detection unit 103, an obstacle detection unit 104, and a drive control unit 105. The functional units 101 to 105 are implemented by cooperation between hardware (such as a CPU) and software (such as a program stored in a memory) constituting the ECU 15. At least one of the functional units 101 to 105 may include dedicated hardware (such as a circuit).

The acquisition unit 101 acquires an acceleration applied to the door 2 to be assisted in the manual operation, the opening degree θ of the door 2, and a distance from the door 2 to an obstacle present in an area in the opening direction (outside the vehicle 1). The acceleration may be acquired from the acceleration sensor 13 installed in the door 2. The opening degree θ may be acquired by an appropriate method, and may be acquired from, for example, a Hall sensor built in the drive unit 11 installed in the door 2. The distance may be acquired from, for example, the obstacle sensor 14 installed in the door 2.

The manual operation detection unit 102 detects the manual operation performed by the user on the door 2 based on the acceleration acquired by the acquisition unit 101. A method for detecting the manual operation based on the acceleration is not particularly limited and may be implemented by appropriately using a known technique. For example, rule-based processing based on a feature of a time-series change in the acceleration, a method using a learned model for estimating presence or absence of the manual operation using the acceleration or the like as an input, or the like may be used.

The state detection unit 103 detects whether the door 2 to be assisted in the manual operation is in a small opening degree state, an intermediate holding state, or a large opening degree state based on the opening degree θ acquired by the acquisition unit 101. The small opening degree state is a state in which the door 2 has a predetermined first opening degree or less. The intermediate holding state is a state in which the door 2 is held at a predetermined second opening degree larger than the first opening degree. The large opening degree state is a state in which the door 2 has a predetermined third opening degree or more, which is larger than the second opening degree.

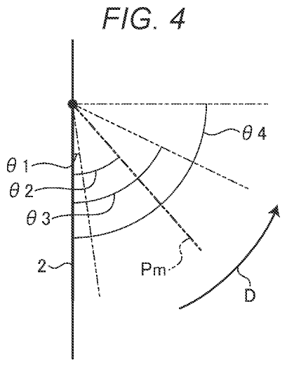

FIG. 4 is a diagram showing an example of a relationship between an opening degree and a state of the door 2 according to the embodiment. FIG. 4 shows the first opening degree θ1, the second opening degree θ2, the third opening degree θ3, and an opening direction D of the door 2.

The first opening degree θ1 is an opening degree when the door 2 is at a position slightly opened from a closed position Pc, and is, for example, an opening degree at which a person cannot get on and off the vehicle 1. A specific numerical value of the first opening degree θ1 should be appropriately set according to specifications of the vehicle 1 or the like, and may be, for example, an angle within a range of 10° to 30°. The small opening degree state is a state in which the opening degree θ (see FIG. 2) is in a range of 0≤θ≤θ1.

The second opening degree 02 is an opening degree larger than the first opening degree θ1, and is, for example, an opening degree at which a person can get on and off the vehicle 1. A specific numerical value of the second opening degree θ2 should be appropriately set according to the specifications of the vehicle 1 or the like, and may be, for example, an angle (for example, about) 45° that is about half the maximum opening degree θ4 (for example, about 90°) when the door 2 is opened to the maximum limit. The intermediate holding state is a state in which the door 2 is held at the intermediate position Pm where the opening degree θ=θ2.

The third opening degree θ3 is an opening degree larger than the second opening degree θ2 and smaller than the maximum opening degree θ4. A specific numerical value of the third opening degree θ3 should be appropriately set according to the specifications of the vehicle 1 or the like, and may be, for example, an angle within a range of 60° to 80°. The large opening degree state is a state in which the opening degree θ is in a range of θ3≤θ≤θ4.

Referring back to FIG. 3, based on the distance acquired by the acquisition unit 101, the obstacle detection unit 104 detects whether an obstacle is present within a predetermined distance of an area in the opening direction from the door 2 to be assisted in the manual operation. The predetermined distance should be appropriately set according to the specifications of the vehicle 1 (for example, a size of the door 2), and may be, for example, a distance within a range of 300 mm to 500 mm.

The drive control unit 105 controls a driving force of the drive unit 11 based on manual operation information indicating a detection result of the manual operation detection unit 102, state information indicating a detection result of the state detection unit 103, and obstacle information indicating a detection result of the obstacle detection unit 104 so as to reduce or increase an operation force required when the user performs the manual operation on the door 2. Hereinafter, the driving force for reducing the operation force is referred to as an assist force, and the driving force for increasing the operation force is referred to as a braking force.

When the user performs an opening operation of opening the door 2 in the small opening degree state (θ≤θ1) and an obstacle is present within the predetermined distance from the door 2, the drive control unit 105 controls the drive unit 11 to generate a strong braking force (an example of a first braking force) for increasing an operation force required for the opening operation. When the user performs an additional opening operation of further opening the door 2 in the intermediate holding state (θ=θ2), the drive control unit 105 controls the drive unit 11 to generate a weak braking force (an example of a second braking force) that is a force for increasing an operation force required for the additional opening operation and is smaller than the strong braking force.

According to the above control, during the additional opening operation from the intermediate holding state, the drive unit 11 is controlled so as to generate the weak braking force that is smaller than the strong braking force generated during the opening operation from the small opening degree state and when the obstacle is present in the vicinity. That is, the user can perform the additional opening operation from the intermediate holding state with the operation force corresponding to the weak braking force smaller than the operation force corresponding to the strong braking force. Accordingly, both safety and convenience during the additional opening operation from the intermediate holding state can be achieved.

When the user performs an opening operation of opening the door 2 in the small opening degree state (θ≤θ1) and no obstacle is present within the predetermined distance from the door 2, the drive control unit 105 controls the drive unit 11 to generate a strong assist force (first assist force) for reducing an operation force required for the opening operation. When the user performs an additional opening operation of further opening the door 2 in the large opening degree state (θ≥θ3) and an obstacle is present within the predetermined distance from the door 2, the drive control unit 105 controls the drive unit 11 to generate a weak assist force (an example of a second assist force) that is a force for reducing an operation force required for the additional opening operation and is smaller than the strong assist force.

According to the above control, during the additional opening operation from the large opening degree state and when the obstacle is present in the vicinity, the drive unit 11 is controlled so as to generate the weak assist force that is smaller than the strong assist force generated during the opening operation from the small opening degree state and when no obstacle is present. Accordingly, convenience during the additional opening operation from the large opening degree state can be improved.

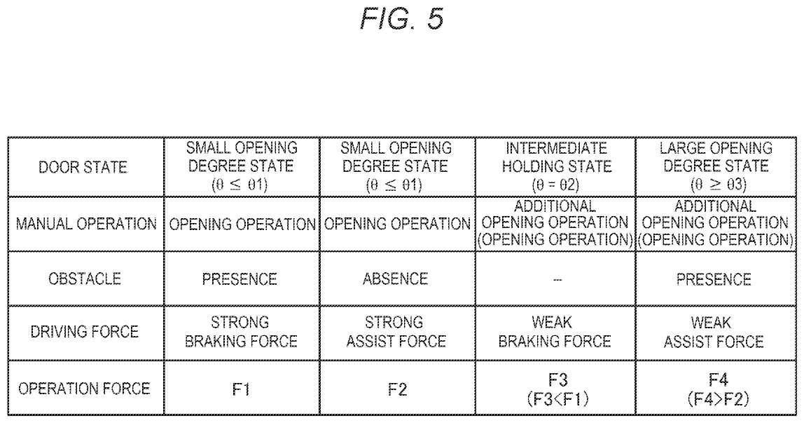

FIG. 5 is a diagram showing an example of a relationship among a state of the door 2, a manual operation, presence or absence of an obstacle, driving force control, and an operation force according to the embodiment. As shown in FIG. 5, in the embodiment, when the state of the door 2 is the intermediate holding state (θ=θ2) and the manual operation is the additional opening operation (an opening operation from the intermediate holding state), the driving force of the drive unit 11 is the weak braking force regardless of presence or absence of the obstacle. Accordingly, the user can perform the additional opening operation with an operation force F3 smaller than an operation force F1 corresponding to the strong braking force.

When the state of the door 2 is the large opening degree state (θ≥θ3), the manual operation is the additional opening operation (an opening operation from the large opening degree state), and the obstacle is present in the vicinity of the door 2, the driving force of the drive unit 11 is the weak assist force. Accordingly, in order for the user to perform the additional opening operation, an operation force F4 larger than an operation force F2 corresponding to the strong assist force is required.

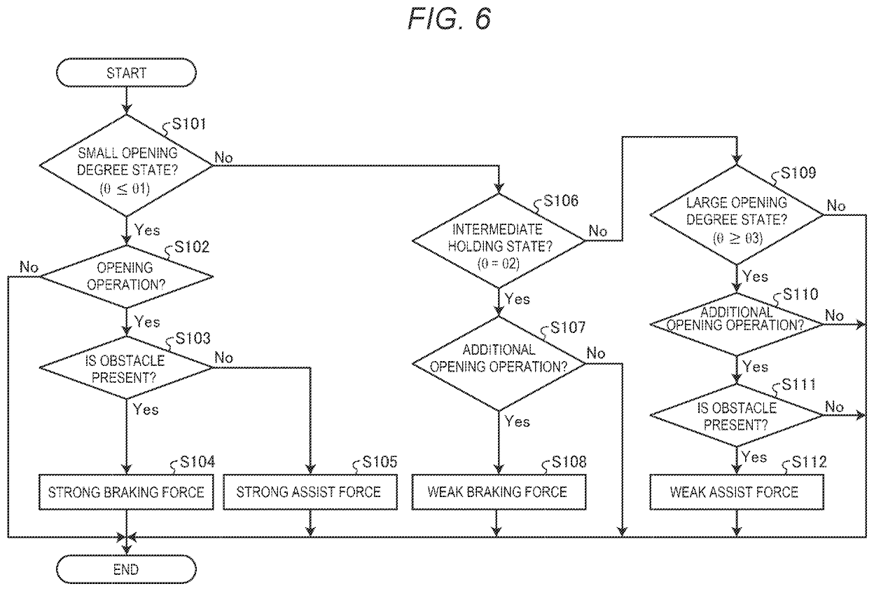

FIG. 6 is a flowchart showing an example of processing executed by the ECU 15 according to the embodiment. The drive control unit 105 determines whether the door 2 is in the small opening degree state (θ≤θ1) based on a detection result of the state detection unit 103 (state information) (S101). When the door 2 is in the small opening degree state (S101: Yes), the drive control unit 105 determines whether an opening operation is performed on the door 2 based on a detection result of the manual operation detection unit 102 (manual operation information) (S102). When the opening operation is not performed (S102: No), this routine ends, and when the opening operation is performed (S102: Yes), the drive control unit 105 determines whether an obstacle is present within the predetermined distance from the door 2 based on a detection result of the obstacle detection unit 104 (obstacle information) (S103). When the obstacle is present (S103: Yes), the drive control unit 105 controls the drive unit 11 such that a driving force is the strong braking force (S104), and when no obstacle is present (S103: No), the drive control unit 105 controls the drive unit 11 such that the driving force is the strong assist force (S105).

When the door 2 is not in the small opening degree state (S101: No), the drive control unit 105 determines whether the door 2 is in the intermediate holding state (θ=θ2) (S106). When the door 2 is in the intermediate holding state (S106: Yes), the drive control unit 105 determines whether an additional opening operation (the opening operation from the intermediate holding state) is performed on the door 2 (S107). When the additional opening operation is performed (S107: Yes), the drive control unit 105 controls the drive unit 11 such that the driving force is the weak braking force (S108), and when the additional opening operation is not performed (S107: No), this routine ends.

When the door 2 is not in the small opening degree state (S106: No), the drive control unit 105 determines whether the door 2 is in the large opening degree state (θ≥θ3) (S109). When the door 2 is not in the large opening degree state (S109: No), this routine ends, and when the door 2 is in the large opening degree state (S109: Yes), the drive control unit 105 determines whether an additional opening operation (an opening operation from the large opening degree state) is performed on the door 2 (S110). When the additional opening operation is not performed (S110: No), this routine ends, and when the additional opening operation is performed (S110: Yes), the drive control unit 105 determines whether an obstacle is present within the predetermined distance from the door 2 (S111). When the obstacle is present (S111: Yes), the drive control unit 105 controls the drive unit 11 such that the driving force is the weak assist force (S112), and when no obstacle is present (S111: No), this routine ends.

According to the above embodiment, during the additional opening operation from the intermediate holding state, the drive unit 11 is controlled so as to generate the weak braking force that is smaller than the strong braking force generated during the opening operation from the small opening degree state and when an obstacle is present in the vicinity. That is, the user can perform the additional opening operation from the intermediate holding state with the operation force F3 corresponding to the weak braking force, which is smaller than the operation force F1 corresponding to the strong braking force. Accordingly, both safety and convenience during the additional opening operation from the intermediate holding state can be achieved.

During the additional opening operation from the large opening degree state and when the obstacle is present in the vicinity, the drive unit 11 is controlled so as to generate the weak assist force that is smaller than the strong assist force generated during the opening operation from the small opening degree state and when no obstacle is present. Accordingly, convenience during the additional opening operation from the large opening degree state can be improved.

A program for causing a computer (such as the ECU 15) to execute processing for implementing a function of the operation assistance system S according to the above embodiment or a modification may be provided as a computer program product stored in a computer-readable storage medium such as a CD-ROM, a CD-R, a memory card, a digital versatile disk (DVD), or a flexible disk (FD) in an installable format or an executable format. The program may be stored on a computer connected to a network such as the Internet and provided by being downloaded via the network. The program may be provided or distributed via a network such as the Internet.

An aspect of this disclosure relates to an operation assistance system for assisting a user in operating an opening and closing portion, and the operation assistance system includes: a sensor configured to detect an acceleration applied to the opening and closing portion; a drive unit configured to generate a driving force for displacing the opening and closing portion; a manual operation detection unit configured to detect, based on the acceleration detected by the sensor, a manual operation of displacing the opening and closing portion when the user applies a force to the opening and closing portion; a state detection unit configured to detect, based on an opening degree of the opening and closing portion, whether the opening and closing portion is in a small opening degree state in which the opening and closing portion has a first opening degree or less, or in an intermediate holding state in which the opening and closing portion is held at a second opening degree larger than the first opening degree; an obstacle detection unit configured to detect a distance from the opening and closing portion to an obstacle present in an area in an opening direction of the opening and closing portion; and a drive control unit configured to control the drive unit to reduce or increase an operation force of the user required for the manual operation based on a detection result of the manual operation detection unit, a detection result of the state detection unit, and a detection result of the obstacle detection unit. When the user performs an opening operation of opening the opening and closing portion in the small opening degree state and the obstacle is present within a predetermined distance from the opening and closing portion, the drive control unit controls the drive unit to generate a first braking force for increasing the operation force required for the opening operation, and when the user performs a first additional opening operation of further opening the opening and closing portion in the intermediate holding state, the drive control unit controls the drive unit to generate a second braking force that is a force for increasing the operation force required for the first additional opening operation and is smaller than the first braking force.

According to the above configuration, during the additional opening operation from the intermediate holding state, the drive unit is controlled so as to generate a weak braking force that is smaller than a strong braking force generated during the opening operation from the small opening degree state and when the obstacle is present in the vicinity. That is, the user can perform the additional opening operation from the intermediate holding state with the operation force corresponding to the weak braking force smaller than the operation force corresponding to the strong braking force. Accordingly, both safety and convenience during the additional opening operation from the intermediate holding state can be achieved.

In the above configuration, the state detection unit may further detect whether the opening and closing portion is in a large opening degree state in which the opening and closing portion has a third opening degree or more, which is larger than the second opening degree. When the user performs an opening operation of opening the opening and closing portion in the small opening degree state and no obstacle is present within the predetermined distance from the opening and closing portion, the drive control unit may control the drive unit to generate a first assist force for reducing the operation force required for the opening operation, and when the user performs a second additional opening operation of further opening the opening and closing portion in the large opening degree state and the obstacle is present within the predetermined distance from the opening and closing portion, the drive control unit may control the drive unit to generate a second assist force that is a force for reducing the operation force required for the second additional opening operation and is smaller than the first assist force.

According to the above configuration, during the additional opening operation from the large opening degree state and when the obstacle is present in the vicinity, the drive unit is controlled so as to generate a weak assist force that is smaller than a strong assist force generated during the opening operation from the small opening degree state and when no obstacle is present. Accordingly, convenience during the additional opening operation from the large opening degree state can be improved.

Another aspect of this disclosure relates to a control device that executes processing of controlling a drive unit that generates a driving force for displacing an opening and closing portion, and the control device includes: a manual operation detection unit configured to detect, based on an acceleration applied to the opening and closing portion, a manual operation of displacing the opening and closing portion when a user applies a force to the opening and closing portion; a state detection unit configured to detect, based on an opening degree of the opening and closing portion, whether the opening and closing portion is in a small opening degree state in which the opening and closing portion has a first opening degree or less, or in an intermediate holding state in which the opening and closing portion is held at a second opening degree larger than the first opening degree; an obstacle detection unit configured to detect a distance from the opening and closing portion to an obstacle present in an area in an opening direction of the opening and closing portion; and a drive control unit configured to control the drive unit to reduce or increase an operation force of the user required for the manual operation based on a detection result of the manual operation detection unit, a detection result of the state detection unit, and a detection result of the obstacle detection unit. When the user performs an opening operation of opening the opening and closing portion in the small opening degree state and the obstacle is present within a predetermined distance from the opening and closing portion, the drive control unit controls the drive unit to generate a first braking force for increasing the operation force required for the opening operation, and when the user performs a first additional opening operation of further opening the opening and closing portion in the intermediate holding state, the drive control unit controls the drive unit to generate a second braking force that is a force for increasing the operation force required for the first additional opening operation and is smaller than the first braking force.

According to the above configuration, during the additional opening operation from the intermediate holding state, the drive unit is controlled so as to generate a weak braking force that is smaller than a strong braking force generated during the opening operation from the small opening degree state and when the obstacle is present in the vicinity. That is, the user can perform the additional opening operation from the intermediate holding state with the operation force corresponding to the weak braking force smaller than the operation force corresponding to the strong braking force. Accordingly, both safety and convenience during the additional opening operation from the intermediate holding state can be achieved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An operation assistance system for assisting a user in operating an opening and closing portion, the operation assistance system comprising:
a sensor configured to detect an acceleration applied to the opening and closing portion;
a drive unit configured to generate a driving force for displacing the opening and closing portion;
a manual operation detection unit configured to detect, based on the acceleration detected by the sensor, a manual operation of displacing the opening and closing portion when the user applies a force to the opening and closing portion;
a state detection unit configured to detect, based on an opening degree of the opening and closing portion, whether the opening and closing portion is in a small opening degree state in which the opening and closing portion has a first opening degree or less, or in an intermediate holding state in which the opening and closing portion is held at a second opening degree larger than the first opening degree;
an obstacle detection unit configured to detect a distance from the opening and closing portion to an obstacle present in an area in an opening direction of the opening and closing portion; and
a drive control unit configured to control the drive unit to reduce or increase an operation force of the user required for the manual operation based on a detection result of the manual operation detection unit, a detection result of the state detection unit, and a detection result of the obstacle detection unit, wherein
when the user performs an opening operation of opening the opening and closing portion in the small opening degree state and the obstacle is present within a predetermined distance from the opening and closing portion, the drive control unit controls the drive unit to generate a first braking force for increasing the operation force required for the opening operation, and when the user performs a first additional opening operation of further opening the opening and closing portion in the intermediate holding state, the drive control unit controls the drive unit to generate a second braking force that is a force for increasing the operation force required for the first additional opening operation and is smaller than the first braking force.

2. The operation assistance system according to claim 1, wherein
the state detection unit further detects whether the opening and closing portion is in a large opening degree state in which the opening and closing portion has a third opening degree or more, which is larger than the second opening degree, and
when the user performs an opening operation of opening the opening and closing portion in the small opening degree state and no obstacle is present within the predetermined distance from the opening and closing portion, the drive control unit controls the drive unit to generate a first assist force for reducing the operation force required for the opening operation, and when the user performs a second additional opening operation of further opening the opening and closing portion in the large opening degree state and the obstacle is present within the predetermined distance from the opening and closing portion, the drive control unit controls the drive unit to generate a second assist force that is a force for reducing the operation force required for the second additional opening operation and is smaller than the first assist force.

3. A control device that executes processing of controlling a drive unit that generates a driving force for displacing an opening and closing portion, the control device comprising:
a manual operation detection unit configured to detect, based on an acceleration applied to the opening and closing portion, a manual operation of displacing the opening and closing portion when a user applies a force to the opening and closing portion;
a state detection unit configured to detect, based on an opening degree of the opening and closing portion, whether the opening and closing portion is in a small opening degree state in which the opening and closing portion has a first opening degree or less, or in an intermediate holding state in which the opening and closing portion is held at a second opening degree larger than the first opening degree;
an obstacle detection unit configured to detect a distance from the opening and closing portion to an obstacle present in an area in an opening direction of the opening and closing portion; and
a drive control unit configured to control the drive unit to reduce or increase an operation force of the user required for the manual operation based on a detection result of the manual operation detection unit, a detection result of the state detection unit, and a detection result of the obstacle detection unit, wherein
when the user performs an opening operation of opening the opening and closing portion in the small opening degree state and the obstacle is present within a predetermined distance from the opening and closing portion, the drive control unit controls the drive unit to generate a first braking force for increasing the operation force required for the opening operation, and when the user performs a first additional opening operation of further opening the opening and closing portion in the intermediate holding state, the drive control unit controls the drive unit to generate a second braking force that is a force for increasing the operation force required for the first additional opening operation and is smaller than the first braking force.
